(19) United States
(12) Patent Application Publication
(10) Pub. No.: US 2025/0100403 A1
(43) Pub. Date: Mar. 27, 2025

(54) VEHICLE CHARGING DEVICE

(71) Applicant: YAZAKI CORPORATION, Tokyo (JP)

(72) Inventors: Koji Ikegaya, Susono-shi (JP); Naoyuki Ikeda, Kakegawa-shi (JP); Yoshitaka Tsushima, Kakegawa-shi (JP); Masaya Okamoto, Kakegawa-shi (JP)

(21) Appl. No.: 18/830,584

(22) Filed: Sep. 11, 2024

(30) Foreign Application Priority Data
Sep. 21, 2023 (JP) 2023-154104

(51) Int. Cl. B60L 53/16; B60L 53/62

(52) U.S. Cl. CPC B60L 53/16; B60L 53/62

(57) ABSTRACT

A vehicle charging device includes a housing that holds a terminal for charging and mates with an inlet disposed on a vehicle, a lock pin disposed in the housing and inserted into a recess of the inlet by protruding from the housing when the housing is mated with the inlet, a drive unit disposed in the housing and allows the lock pin to protrude from the housing, and a detection unit that detects a state of insertion of the lock pin or an abnormality in the drive unit.

### CROSS-REFERENCE TO RELATED APPLICATION(S)

The present application claims priority to and incorporates by reference the entire contents of Japanese Patent Application No. 2023-154104 filed in Japan on Sep. 21, 2023.

### BACKGROUND OF THE INVENTION

### 1. Field of the Invention

The present invention relates to a vehicle charging device.

### 2. Description of the Related Art

Conventionally, charging devices that charge vehicles have been known. A vehicle charging system disclosed in Japanese Patent Application Laid-open No. 2022-26379 includes a power feed device having a power feed mating and provided in a stop space of a vehicle. The vehicle charging system has an insertion/extraction direction portion that mates the power feed mating with a power receiving mating of a vehicle.

The reliability of mating control is desirably improved when a housing of a charging connector is mated with an inlet of a vehicle.

### SUMMARY OF THE INVENTION

An object of the present invention is to provide a vehicle charging device that can improve the reliability of mating control.

In order to achieve the above mentioned object, a vehicle charging device according to one aspect of the present invention includes a housing that holds a terminal for charging and mates with an inlet disposed on a vehicle; a lock pin disposed in the housing and inserted into a recess of the inlet by protruding from the housing when the housing is mated with the inlet; a drive unit disposed in the housing and allows the lock pin to protrude from the housing; and a detection unit that detects a state of insertion of the lock pin or an abnormality in the drive unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a vehicle charging device according to an embodiment;

FIG. 2 is a perspective view of the vehicle charging device according to the embodiment;

FIG. 3 is a side view of the vehicle charging device according to the embodiment;

FIG. 4 is a perspective view of a connector according to the embodiment;

FIG. 5 is a diagram of the vehicle charging device according to the embodiment;

FIG. 6 is a perspective view of an inlet according to the embodiment;

FIG. 7 is a sectional view of the inlet according to the embodiment; and

FIG. 8 is a sectional view of the inlet and the connector according to the embodiment.

### DETAILED DESCRIPTION OF THE PREFERRED EMBODIMENTS

The following is a detailed description of a vehicle charging device according to an embodiment of the present invention with reference to the drawings. This invention is not limited by this embodiment. Components in the following embodiment include those that can be readily assumed by those skilled in the art or are substantially the same.

### Embodiment

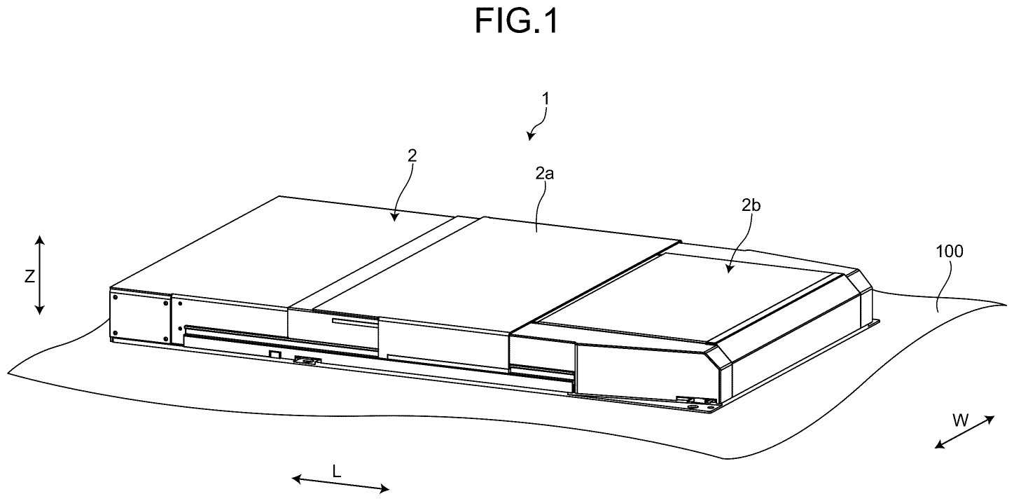

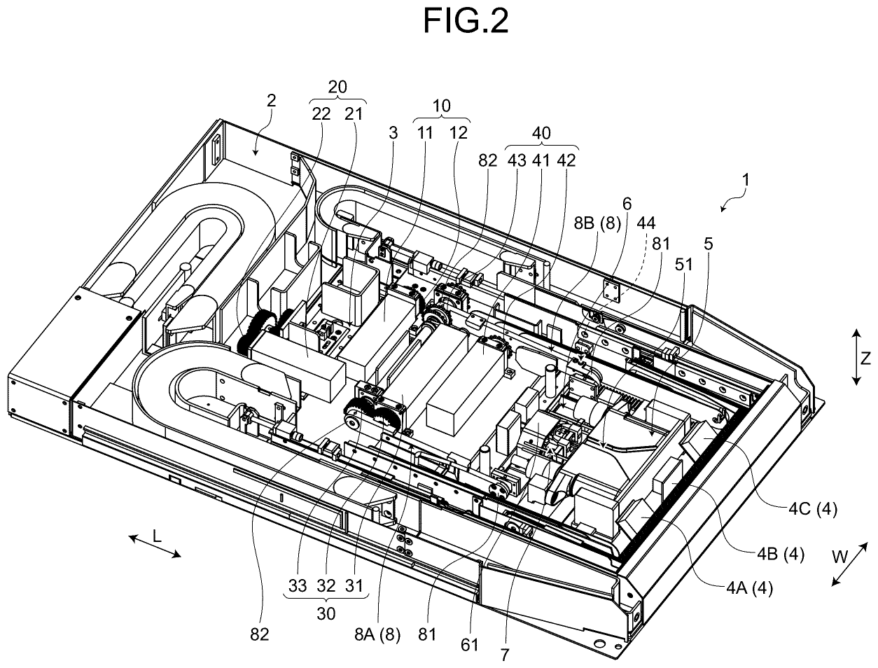

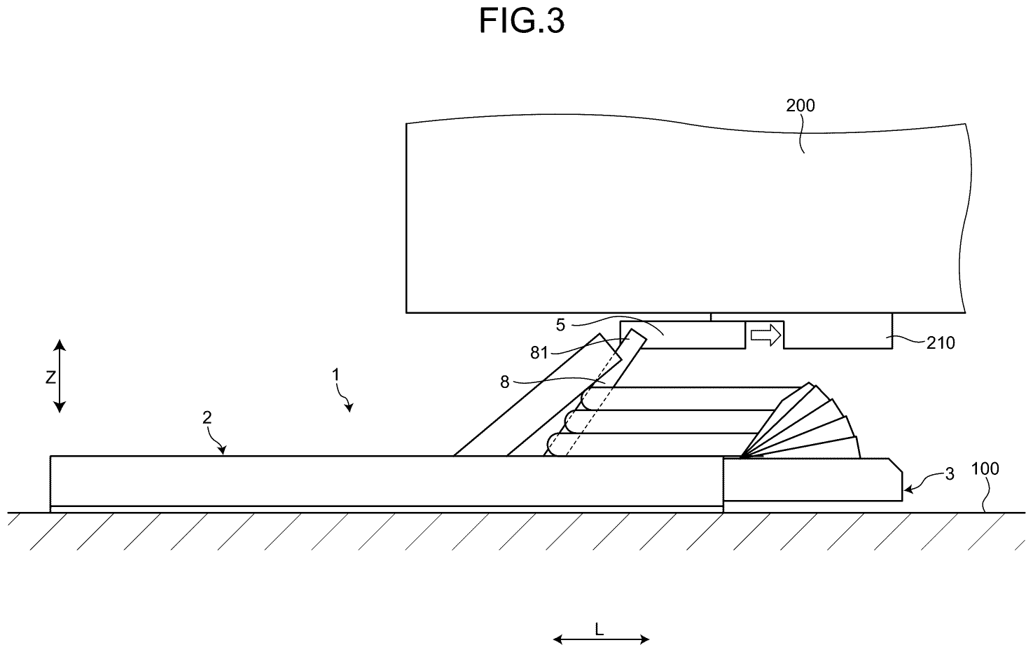

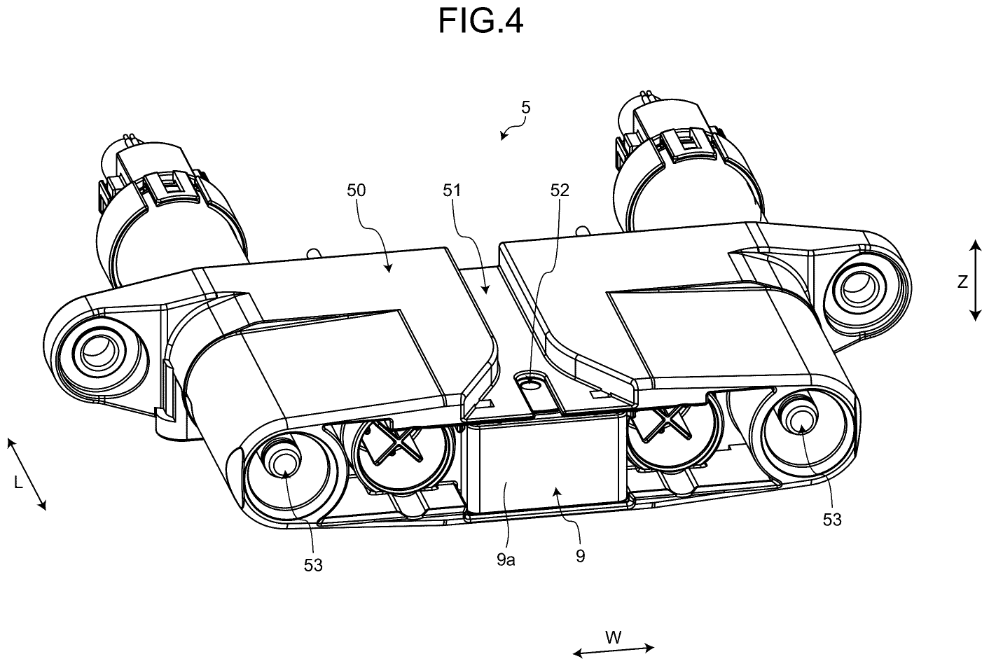

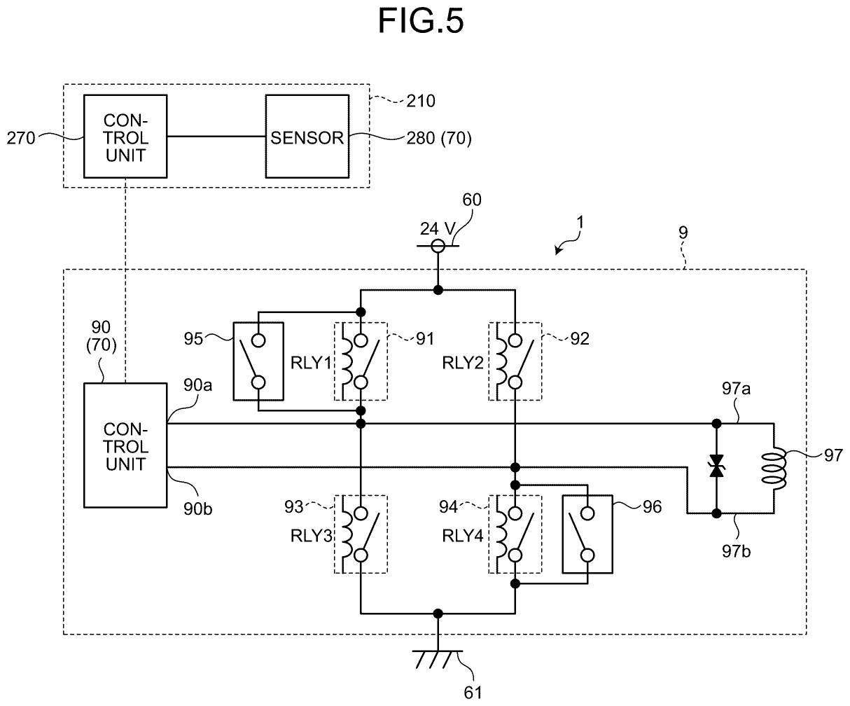

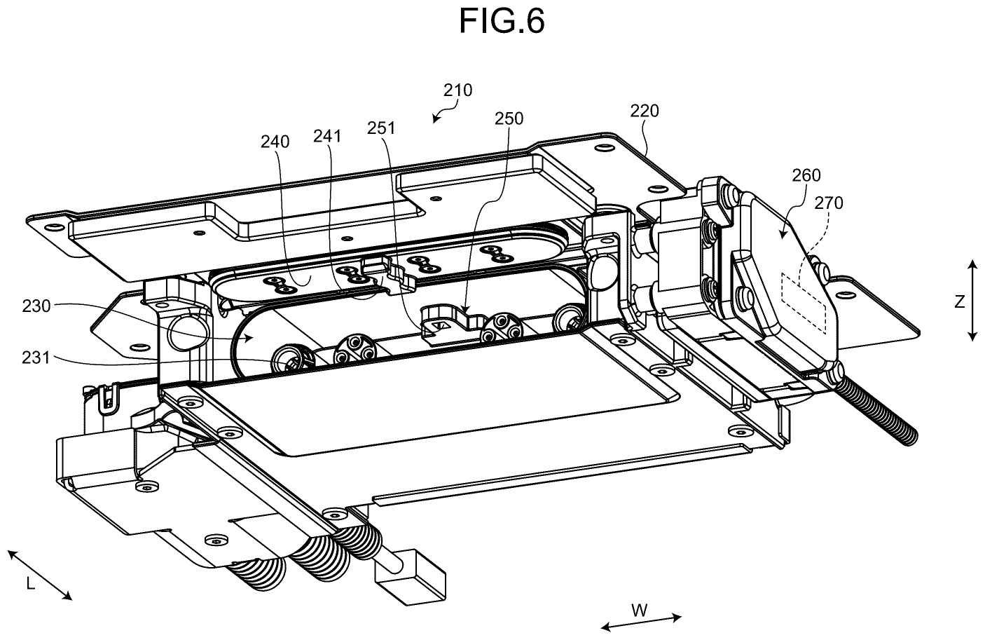

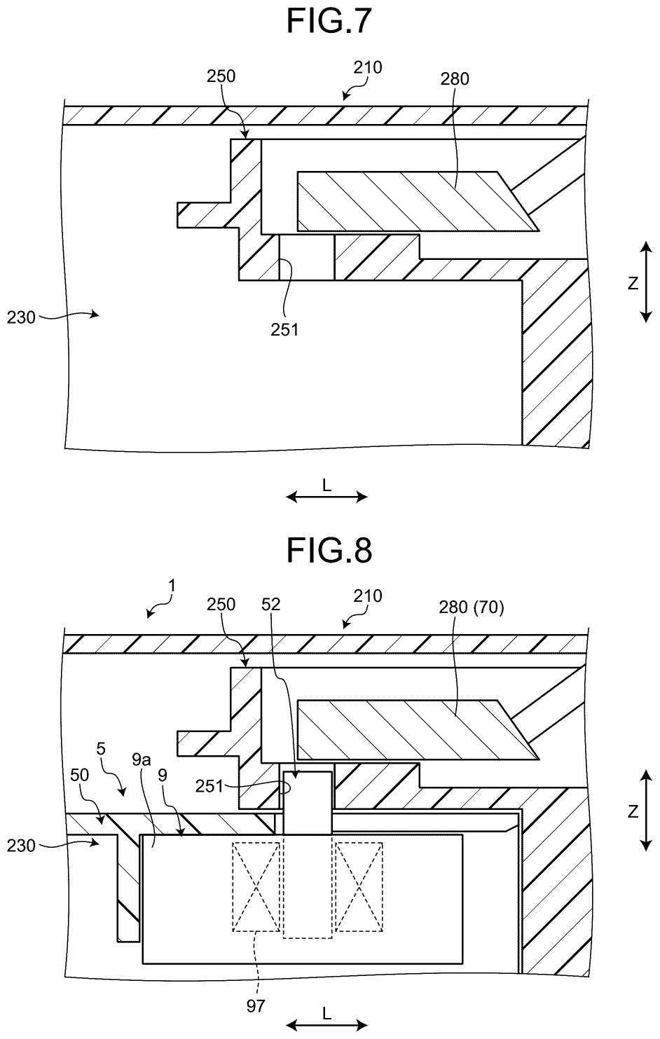

With reference to FIGS. 1 to 8, an embodiment is described. The present embodiment relates to a vehicle charging device. FIGS. 1 and 2 are perspective views of the vehicle charging device according to the embodiment, FIG. 3 is a side view of the vehicle charging device according to the embodiment, FIG. 4 is a perspective view of a connector according to the embodiment, FIG. 5 is a diagram of the vehicle charging device according to the embodiment, FIG. 6 is a perspective view of an inlet according to the embodiment, FIG. 7 is a sectional view of the inlet according to the embodiment, and FIG. 8 is a sectional view of the inlet and the connector according to the embodiment.

As illustrated in FIG. 1, a vehicle charging device 1 of the present embodiment is placed on a floor 100 of a stop space where a vehicle is stopped. The vehicle charging device 1 has a case 2. The case 2 is fixed to the floor 100. The case 2 has a sliding cover 2a and a pivoting cover 2b. The covers 2a and 2b cover a device housed in an interior space of the case 2 from the top.

As illustrated in FIG. 2, the vehicle charging device 1 has a slide body 3 disposed inside the case 2. The slide body 3 is a plate-shaped base member that can move in a first direction L and a second direction W with respect to the case 2. The first direction L and the second direction

W are horizontal directions. When a floor surface of the floor 100 is inclined, the first direction L and the second direction W are preferably horizontal to the floor surface of the floor 100.

The first direction L corresponds to a vehicle front-back direction of a vehicle 200 to be charged. The second direction W corresponds to a vehicle width direction of the vehicle 200. The vehicle 200 is positioned at a charging position, at which the vehicle 200 is charged by the vehicle charging device 1, while moving forward or backward along the first direction L. In the illustrated vehicle charging device 1, the first direction L is a longitudinal direction of the case 2. The second direction W is a transverse direction of the case 2 and is orthogonal to the first direction L.

The vehicle charging device 1 has a sensor 4, a connector 5, a support member 6, a connecting mechanism 7, and an arm 8. The vehicle charging device 1 further has a first drive mechanism 10, a second drive mechanism 20, a third drive mechanism 30, and a fourth drive mechanism 40.

As illustrated in FIG. 3, the connector 5 mates with an inlet 210 disposed on the vehicle 200. The inlet 210 is disposed at the bottom of the vehicle 200. The connector 5 is connected to a battery of the vehicle 200 by mating with the inlet 210.

The sensor 4 is used to detect the position of the inlet 210. In the present embodiment, the sensor 4 is a laser sensor that detects a distance to a reflective object by using a laser beam. The sensor 4 emits a laser beam in a predetermined direction and receives the laser beam reflected by the object.

The sensor 4 is disposed on the slide body 3 and moves with the slide body 3. The sensor 4 illustrated in FIG. 2 has a first sensor 4A, a second sensor 4B, and a third sensor 4C. The three sensors 4A, 4B, and 4C are arranged side by side in this order in the second direction W. The second sensor 4B emits a laser beam toward an upper side in a vertical direction Z. The vertical direction is a direction orthogonal to both the first direction L and the second direction W, and corresponds to the vehicle vertical direction of the vehicle 200. The first sensor 4A and the third sensor 4C emit laser beams in an oblique direction inclined with respect to the vertical direction Z.

The connector 5 is a charging connector that charges the battery of the vehicle 200. The connector 5 has terminals for charging. The vehicle charging device 1 of the present embodiment is configured so that the position of the connector 5 can be moved in the first direction L, the second direction W, and the vertical direction Z.

The first drive mechanism 10 is a mechanism that moves the connector 5 in the first direction L. The first drive mechanism 10 has a first motor 11 and a gear 12. The gear 12 is disposed on an output shaft of the first motor 11 and meshes with a rack gear disposed on the slide body 3. The first motor 11 can move the connector 5 in the first direction L by rotating in forward and reverse directions.

The second drive mechanism 20 is a mechanism that moves the connector 5 in the second direction W. The second drive mechanism 20 has a second motor 21 and a gear 22. The gear 22 is disposed on an output shaft of the second motor 21. The gear 22 meshes with a rack gear disposed in the case 2 via a reduction gear. The second motor 21 can move the slide body 3 in the second direction W by rotating in forward and reverse directions.

The third drive mechanism 30 is a mechanism that moves the connector 5 in the vertical direction Z. The connector 5 is connected to the slide body 3 via the arm 8, the support member 6, and the connecting mechanism 7. The arm 8 is a plate-shaped member and has a first end 81 and a second end 82. The first end 81 is connected to the support member 6. The second end 82 is pivotably supported by the slide body 3. That is, the arm 8 can rotate with the second end 82 as its center of rotation. The arm 8 moves the support member 6 up and down by pivoting.

The vehicle charging device 1 of the present embodiment has a first arm 8A and a second arm 8B. The first arm 8A and the second arm 8B extend in the first direction L and face each other in the second direction W. The second ends 82 of the two arms 8A and 8B are connected to each other via a shaft. Accordingly, the two arms 8A and 8B rotate in tandem.

The support member 6 is connected to the first end 81 of the first arm 8A and the first end 81 of the second arm 8B. The support member 6 is a plate-shaped member and extends in the second direction W. The support member 6 is axially supported by the first end 81 of the arm 8 to be rotatable relative to the arm 8.

The connecting mechanism 7 connects the connector 5 to the support member 6 and is configured to allow changes in the orientation of the connector 5. The connecting mechanism 7 has, for example, a universal joint and a spring.

The third drive mechanism 30 moves the connector 5 in the vertical direction Z by pivoting the arm 8. As illustrated in FIG. 2, the third drive mechanism 30 has a third motor 31, a first gear 32, and a second gear 33. The first gear 32 is disposed on an output shaft of the third motor 31. The second gear 33 is connected to the shaft connecting the two arms 8A and 8B and meshes with the first gear 32. The third motor 31 rotates the arm 8 by rotating in forward and reverse directions.

The fourth drive mechanism 40 is configured to change an angle θ of the connector 5. The angle θ is an inclination angle of the connector 5 with respect to the first direction L. The fourth drive mechanism 40 has a fourth motor 41, a first sprocket 42, and a pair of second sprockets 43. The first sprocket 42 is disposed on an output shaft of the fourth motor 41. The second sprockets 43 are coaxially disposed with the shaft connecting the arms 8A and 8B, and rotate relative to the shaft. An endless chain is hung around the first sprocket 42 and the second sprockets 43. A third sprocket 44 is disposed on the support member 6. An endless chain is hung around the second sprockets 43 and the third sprocket 44. The fourth motor 41 rotates the support member 6 relative to the arms 8A and 8B by rotating in forward and reverse directions. The rotation of the support member 6 changes the angle 0 of the connector 5.

As illustrated in FIG. 4, the connector 5 of the present embodiment has a housing 50. The housing 50 is molded, for example, of an insulating synthetic resin. The housing 50 has a cylindrical shape that mates with the inlet 210. The sectional shape of the illustrated housing 50 is a substantially oval shape. The housing 50 holds terminals 53 for charging. The illustrated terminals 53 are male terminals. A top surface of the housing 50 is provided with a groove 51. The groove 51 extends along an axial direction of the housing 50.

A lock pin 52 is disposed in the housing 50. The lock pin 52 is disposed to be able to protrude in the groove 51 along the vertical direction Z. The lock pin 52 is made of metal and has a cylindrical shape. Inside the housing 50, a drive unit 9 that drives the lock pin 52 is disposed.

The drive unit 9 has a case 9a having a substantially rectangular parallelepiped shape. The lock pin 52 is driven in the vertical direction Z by an electromagnetic force generated by a solenoid disposed inside the case 9a.

As illustrated in FIG. 5, the drive unit 9 has a first relay 91, a second relay 92, a third relay 93, a fourth relay 94, manual switches 95 and 96, and a solenoid 97. The solenoid 97 is a solenoid coil that exerts a driving force on the lock pin 52. The solenoid 97 has a first terminal 97a and a second terminal 97b disposed at both ends of the coil. The drive unit 9 has a control circuit that controls the energization of the solenoid 97. The control circuit includes the first relay 91, the second relay 92, the third relay 93, and the fourth relay 94.

The first relay 91 is interposed between a power source 60 of the vehicle charging device 1 and the first terminal 97a. The second relay 92 is interposed between the power source 60 and the second terminal 97b. The third relay 93 is interposed between the first terminal 97a and a ground 61 of the vehicle charging device 1. The fourth relay 94 is interposed between the second terminal 97b and the ground 61. A control unit 90 is a control device that performs ON/OFF control for the relays 91, 92, 93, and 94, and is, for example, a microcomputer. The control unit 90 may be disposed in the case 2 of the vehicle charging device 1, or may be disposed in a control panel or the like outside the case 2.

The solenoid 97 exerts a driving force on the lock pin 52 in the insertion/extraction direction according to the direction of a current flowing through the coil. When a driving force is applied to the lock pin 52 in the direction in which the lock pin 52 protrudes from the case 9a, the control unit 90 closes the second relay 92 and the third relay 93 and opens the first relay 91 and the fourth relay 94. This allows the lock pin 52 to be inserted into a recess 251 (see FIG. 6) of the inlet 210.

When a driving force is applied to the lock pin 52 in the direction of pulling the lock pin 52 into the case 9a, the control unit 90 closes the first relay 91 and the fourth relay 94 and opens the second relay 92 and the third relay 93. This allows the lock pin 52 to be pulled out of the recess 251 and housed in the case 9a.

The vehicle charging device 1 of the present embodiment has a detection unit 70 that detects the state of insertion of the lock pin 52 or an abnormality in the drive unit 9. The control unit 90 of the present embodiment detects relay on-failures as the detection unit 70 as described below. More specifically, the control unit 90 is configured to detect an on-failure of the first relay 91 and an on-failure of the second relay 92. As illustrated in FIG. 5, the control unit 90 has a port 90a for monitoring a voltage at the first terminal 97a and a port 90b for monitoring a voltage at the second terminal 97b. When the first relay 91 is closed, the port 90a is HI, and when the first relay 91 is open, the port 90a is LO. When the second relay 92 is closed, the port 90b is HI, and when the second relay 92 is open, the port 90b is LO.

When the port 90a is HI in a case in which the first relay 91 is controlled in the open state, the control unit 90 determines that the first relay 91 is on-failure. When the port 90b is HI in a case in which the second relay 92 is controlled in the open state, the control unit 90 determines that the second relay 92 is on-failure.

The manual switches 95 and 96 are manually operated switches. The manual switch 95 is a switch that bypasses the first relay 91. The manual switch 96 is a switch that bypasses the fourth relay 94. The manual switches 95 and 96 are used, for example, when the power source 60 has a failure. In this case, an external power source such as a battery is connected as a power source for the drive unit 9 instead of the power source 60. When the manual switches 95 and 96 are manually closed, a current from the external power source flows through the solenoid 97, so that a driving force can be applied to the lock pin 52 in the direction of puling the lock pin 52 out of the inlet 210.

As illustrated in FIG. 6, the inlet 210 has a base 220, a mating portion 230, and a cover 240. The base 220 is a portion that is fixed to the vehicle 200 and has a substantially flat plate shape. The mating portion 230 projects downward from the base 220 in the vertical direction Z. The mating portion 230 has an opening into which the housing 50 of the connector 5 is inserted. Terminals 231 corresponding to the terminals 53 are housed inside the mating portion 230. The terminals 231 are, for example, female terminals.

The cover 240 closes or opens the opening of the mating portion 230. FIG. 6 illustrates an open state in which the cover 240 opens the opening. The inlet 210 has an actuator 260 that drives the cover 240. The actuator 260 has a control unit 270 that controls an operation of the actuator 260. The control unit 270 is, for example, a control board. The control unit 270, for example, opens and closes the cover 240 in response to commands output from an ECU of the vehicle 200.

A linear protrusion 241 that guides the connector 5 is disposed on the cover 240. The protrusion 241 guides the groove 51 of the housing 50. A positioning protrusion 250 is disposed inside the mating portion 230. The protrusion 250 is disposed on an extension line of the protrusion 241. The protrusion 250 is inserted into the groove 51 of the housing 50 to position the housing 50.

The protrusion 250 has the recess 251 recessed in the vertical direction Z. The recess 251 opens downward. The shape of the recess 251 is such that the lock pin 52 of the connector 5 can be inserted. The recess 251 is disposed to face the lock pin 52 when the housing 50 is inserted to the back of the mating portion 230. In other words, the recess 251 faces the lock pin 52 when the housing 50 is completely mated with the mating portion 230.

As illustrated in FIG. 7, a sensor 280 is disposed on the protrusion 250. The sensor 280, as the detection unit 70, detects the state of insertion of the lock pin 52 into the recess 251. The sensor 280 is, for example, a proximity sensor that detects the proximity of the lock pin 52 to the sensor 280. The sensor 280, for example, uses a magnetic field to detect the proximity of metal. As illustrated in FIG. 8, the sensor 280 is disposed to face the tip of the lock pin 52 inserted into the recess 251. The sensor 280 is configured to detect whether the lock pin 52 is properly inserted into the recess 251.

As illustrated in FIG. 5, the control unit 270 of the inlet 210 acquires a detection result of the sensor 280. The control unit 270 of the inlet 210 is communicatively connected to the control unit 90 of the vehicle charging device 1. Another control unit or device may be interposed between the two control units 90 and 270. That is, the control unit 90 is connected to the control unit 270 of the inlet 210 to be able to transmit information to each other.

When it is detected that the housing 50 is completely mated with the mating portion 230, the control unit 90 of the vehicle charging device 1 causes the lock pin 52 to protrude from the case 9a. FIG. 8 illustrates the lock pin 52 inserted into the recess 251. The housing 50 of the connector 5 is inserted to the completely mated position in the mating portion 230. The lock pin 52 protrudes upward from the case 9a of the drive unit 9 and is inserted into the recess 251. The recess 251 engages the lock pin 52 and restricts movement of the housing 50 in the extraction direction.

The control unit 90 of the vehicle charging device 1 acquires the detection result of the lock pin 52 by the sensor 280 from the control unit 270 of the inlet 210. The vehicle charging device 1 permits charging to the vehicle 200 when the sensor 280 detects the lock pin 52. That is, the vehicle charging device 1 charges the vehicle 200 with the connector 5 locked to the inlet 210. This suppresses coming out of the connector 5 from the inlet 210 during charging.

When the charging is completed, the control unit 90 causes the lock pin 52 to be housed in the case 9a. At this time, the control unit 90 acquires the detection result of the lock pin 52 by the sensor 280 from the control unit 270 of the inlet 210. The vehicle charging device 1 pulls the connector 5 out of the inlet 210 after confirming that the sensor 280 does not detect the lock pin 52. This suppresses pulling out of the connector 5 with the lock pin 52 protruding.

As described above, the vehicle charging device 1 of the present embodiment has the housing 50, the lock pin 52, the drive unit 9, and the detection unit 70. The housing 50 holds the terminals 53 for charging and mates with the inlet 210 disposed on the vehicle 200. The lock pin 52 is disposed in the housing 50. The lock pin 52 is inserted into the recess 251 of the inlet 210 by protruding from the housing 50 when the housing 50 is mated with the inlet 210. The drive unit 9 is disposed in the housing 50 and allows the lock pin 52 to protrude from the housing 50. The detection unit 70 detects the state of insertion of the lock pin 52 or an abnormality in the drive unit 9. The vehicle charging device 1 of the present embodiment has the lock pin 52 that is inserted into the recess 251, so that the vehicle 200 can be charged with the connector 5 locked to the inlet 210. In addition, the vehicle charging device 1 has the detection unit 70 that detects the state of insertion of the lock pin 52 or an abnormality in the drive unit 9, so that the reliability of the operation of the lock pin 52 can be improved. That is, the vehicle charging device 1 of the present embodiment can improve the reliability of mating control for the inlet 210.

The detection unit 70 of the present embodiment has the sensor 280 disposed in the inlet 210. The sensor 280 detects the state of insertion of the lock pin 52 into the recess 251. Thus, the vehicle charging device 1 of the present embodiment can confirm that the lock pin 52 is actually inserted into the recess 251.

The detection unit 70 of the present embodiment has the control unit 90 that controls the drive unit 9. The drive unit 9 has the solenoid 97 that exerts a driving force on the lock pin 52 in the insertion/extraction direction relative to the recess 251, and the relays 91 and 92 that control the energization of the solenoid 97. The control unit 90 detects an on-failure of the relays 91 and 92. Thus, the vehicle charging device 1 of the present embodiment can suppress malfunction of the lock pin 52.

The detection unit 70 may have a self-diagnostic circuit provided in the relay. For example, each of the relays 91, 92, 93, and 94 is provided with a self-diagnostic circuit to detect its own on-failure. When an on-failure is detected, the self-diagnostic circuit outputs a signal indicating the occurrence of the on-failure to the control unit 90. When no on-failure is detected, the self-diagnostic circuit may output a signal indicating normality to the control unit 90.

Details disclosed in the above embodiment can be combined and implemented as appropriate.

A vehicle charging device according to the present embodiment includes a lock pin that is inserted into a recess of an inlet by protruding from a housing when the housing is mated with the inlet, a drive unit that causes the lock pin to protrude from the housing, and a detection unit that detects the state of insertion of the lock pin or an abnormality in the drive unit. The vehicle charging device according to the present embodiment has an effect of being able to improve the reliability of mating control.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle charging device comprising:
a housing that holds a terminal for charging and mates with an inlet disposed on a vehicle;
a lock pin disposed in the housing and inserted into a recess of the inlet by protruding from the housing when the housing is mated with the inlet;
a drive unit disposed in the housing and allows the lock pin to protrude from the housing; and
a detection unit that detects a state of insertion of the lock pin or an abnormality in the drive unit.

2. The vehicle charging device according to claim 1, wherein
the detection unit comprises a sensor disposed in the inlet, and
the sensor detects the state of insertion of the lock pin into the recess.

3. The vehicle charging device according to claim 1, wherein
the detection unit comprises a control unit that controls the drive unit,
the drive unit comprises a solenoid that exerts a driving force on the lock pin in an insertion/extraction direction relative to the recess and a relay that controls an energization of the solenoid, and
the control unit detects an on-failure of the relay.
